(19) United States
(12) Patent Application Publication
(10) Pub. No.: US 2011/0045261 A1
(43) Pub. Date: Feb. 24, 2011

(54) LAMINATE NON-WOVEN SHEET WITH HIGH-STRENGTH, MELT-BLOWN FIBER EXTERIOR LAYERS

(75) Inventor: William R. Sellars, Milwaukee, WI (US)

Correspondence Address: MICHAEL BEST & FRIEDRICH LLP, 100 E WISCONSIN AVENUE, Suite 3300, MILWAUKEE, WI, 53202, US

(73) Assignee: SELLARS ABSORBENT MATERIALS, INC., Milwaukee (US)

(21) Appl. No.: 12/918,212

(22) PCT Filed: Feb. 18, 2009
(86) PCT No.: PCT/US09/34427

§ 371 Date: Sep. 27, 2010

Related U.S. Application Data
(60) Provisional application No. 61/029,533, filed on Feb. 18, 2008.
(60) Provisional application No. 61/029,531, filed on Feb. 18, 2008.

(51) Int. Cl. B32B 5/26; D04H 1/16; B32B 7/02; B32B 37/16

(52) U.S. Cl. 428/213; 442/387; 442/381; 156/244.11; 156/500

(57) ABSTRACT

A laminate non-woven sheet including a first layer, a second layer, and a middle layer. In one embodiment, the first layer consists of melt-blown fibers (and no other type of fibers), the melt-blown fibers have a strength of at least about 5 gpd or more and the first layer has a thickness. The second layer consists of melt-blown fibers (and no other type of fibers), the melt-blown fibers have a strength of about 5 gpd or more and the second layer has a thickness that is substantially the same as the thickness of the first layer. The middle layer is positioned between the first and second layers. The middle layer includes a dry-laid web of cellulose fibers. The middle layer is secured to the first and second layers by at least one of a group of bonds created by fusing fibers in the first, second, and middle layers or hydroentangling the first, second, and middle layers.

### RELATED APPLICATIONS AND PRIORITY CLAIM

This application claims priority to U.S. Provisional Patent Application No. 61/029,531 filed on Feb. 18, 2008, and to U.S. Provisional Patent Application No. 61/029,533 filed on Feb. 18, 2008. The contents of these two applications are incorporated herein by reference.

### BACKGROUND

Embodiments of the invention relate to non-woven materials and, more particularly, to laminates of non-woven materials.

Non-woven materials are used to make a variety of products such as dry and wet wipes (or wipers), towels, and industrial absorbents. Non-woven materials are also used to make filters, disposable medical products (such as gowns and masks), and diapers.

Non-woven materials are created from a non-woven web of fibers. Nonwoven technologies are categorized by both the manner in which non-woven webs are formed and also the manner in which the webs are held or bonded together.

Non-woven webs may be made from a single type of fiber (or material). It is also possible to use multiple types of fibers or to add other materials to the fibers, such as particulates, to make a non-woven product. Creating a laminate is one approach to making a non-woven, composite product, as the layers of the laminate can be made, for example, from different fibers. Another way of making a non-woven, composite product is to mix different types of fibers within each layer with one or more other types of fibrous materials, particulates, or a combination of fibrous materials and particulates.

One way of making a non-woven web is to use what is referred to as a melt-blown process. In a melt-blown process, fibers are formed from a thermo-plastic material that is heated to a liquid or molten state and then forced through small openings, die bodies, or nozzles of an extruder. Jets of air are directed at the molten material exiting the nozzles such that fibers of the material are formed. The fibers may then be collected or deposited on a moving screen (a continuous belt) (sometimes referred to as a “forming table”) to create a non-woven web of the thermo-plastic material.

One way of creating a composite non-woven web made (at least in part) from melt-blown material is to use a process with two or mores streams of material. For example, U.S. Pat. No. 5,350,624, (the “'624 patent”) discloses a process for making a non-woven composite structure in which a stream of cellulose materials is sandwiched between two streams of melt-blown materials. The cellulose stream contacts the two streams of melt-blown material before the melt-blown fibers are completely hardened (or cooled). At least some of the cellulose fibers and melt-blown fibers are mechanically entangled. In addition, at least some of the cellulose adheres to the semi-molten or tacky thermo-plastic fibers. A composite, non-woven material having a graduated distribution of fibers is created (where thermo-plastic fibers and cellulose are present at the exterior surfaces of the end-product at a percentage of about 60 percent or more thermo-plastic. In the middle, thermo-plastic and cellulose are present at a percentage of about 60 percent or more cellulose and about 40 percent or less of thermo-plastic.

### SUMMARY

Although the non-woven materials and methods of manufacturing described above are known, there continues to be a need for high-strength, high-performance wipes that are made cost effectively. As noted, wipes are sometimes made from thermo-plastic materials. Thermo-plastic materials are made from petroleum. As a consequence, wipes and other non-woven products that use thermo-plastic fibers are very cost sensitive. At the same time, the market continues to demand higher and higher performance, which in accordance to conventional wisdom generally requires the use of petroleum-derived, synthetic fibers to achieve.

Fiber made from thermoplastic materials can be manufactured as a continuous filament and can be quite strong. Melt-blown continuous filament fibers can be quite soft. Cellulose fibers (made from trees) are quite short and can produce linting, but they are highly absorbent. Cellulose fiber can sometimes be coarse to the touch compared to some thermoplastic fibers. Thermoplastic fibers are, in general, much more expensive than cellulose fibers.

While wipes may appear very simple, a number of attributes are considered in their design and manufacture. Chief among these are strength, softness, absorbency, bulk (i.e. thickness), linting, and cost. Embodiments of the invention provide a wipe that is strong, soft, absorbent, and bulky, with low linting at an economic cost. The inventors have designed a new laminate structure for a composite, non-woven wipe and methods of making such a wipe where the use of high-cost materials can be reduced and the use of lower cost cellulose and other natural fibers can be increased. In addition, embodiments of the invention still provide high-performance in terms of, for example, limited linting (a problem associated with non-woven materials made with short cellulose fibers). Further still, certain embodiments improve the strength of the wipe.

The inventors have also designed a new laminate structure for a composite, non-woven wipe and methods of making such a wipe, where complex mixing of fibers in a melt-blown process is reduced. For example, in the melt-blown process described in the '624 patent, the velocity of the air stream carrying cellulose fibers and streams carrying the melt-blown fibers must be regulated and controlled so that a desired, graduated distribution of fibers is created in the non-woven web. While such control and regulation appears to be possible to achieve, it does, in the opinion of the inventors, tend to increase the complexity of the manufacturing process.

Accordingly, embodiments of the invention provide a composite, non-woven product that includes multiple layers of material. In one form, the non-woven product includes a first, outer layer made from melt-blown fibers and no other type of fibers; a second outer layer also made from melt-blown fibers and no other type of fibers; and a third, middle layer positioned between the first and second outer layers. In one embodiment, the melt-blown fibers in the first and second outer layers are high-strength fibers. In a particular embodiment, the high-strength fibers exhibit a strength or fiber tenacity (measured in grams per denier (“gpd”)) of at least about 5.0. Such fibers can be produced in a process in which a flow of quench air is directed at molten fibers exiting the nozzles of an extruder parallel to the direction in which the fibers exit the nozzles.

The third, middle layer is made from cellulose fibers or a combination of different types of fibers. For example, in one embodiment, a homogenization of melt-blown fibers and cellulose is used. The melt-blown fibers in the third, middle layer can be low-strength fibers (e.g., fibers having a fiber tenacity of about 4 gpd or less) or high-strength fibers (such as those mentioned above). The lower strength meltbown fibers tend to be of high denier (i.e. thicker). When combined with the cellulose fibers, these thicker denier fibers produce a bulky middle layer that is also more absorbent. Other combinations or substitutions of fibers are also possible. For example, the third, middle layer can be made exclusively of cotton fibers, cellulose and cotton fibers, or a combination of cellulose, cotton fibers, and melt-blown fibers.

One method is to use diebodies with multiple rows of holes. This enables the fiber to be run at a much lower throughput per hole and at a cooler temperature. As a consequence, the fiber is attenuated or drawn to a greater degree (than is otherwise possible). Attenuating the fiber orients the molecular chains of the fiber in a manner that increases the strength of the fiber. However, since the fiber is cooler than ordinary melt-blown fibers, it may not adhere to other fibers in the same way that melt-blown produced in an ordinary manner would. To address this concern, bicomponent fiber may be extruded through the diebodies to create a bicomponent melt-blown fiber. The bicomponent melt-blown fiber can be later heated to help create bonds between fibers.

Melt-blown fibers in the first, second, and third layers may be comprised of bicomponent fibers (i.e., fibers with a co-axial or side-by-side arrangement of synthetic fibers with different melting points, where a higher-melting point fiber is surrounded by or adjacent to a lower-melting point fiber).

Once the multiple-layer or laminate sheet is formed the three layers (the first and second outer layers and the third, middle layer) are bonded or more securely attached to one another. In one embodiment, the laminate sheet is heated so that the lower-melting point fiber in the bicomponent fibers melts. The molten fiber adheres to other fibers in the laminate and when the laminate is cooled, bonds are created between the fibers in the different layers. In another embodiment, usually when bicomponent fiber is not used, the laminate is secured through hydroentangling the fibers in the layers.

Unlike the product disclosed in the '624 patent, embodiments of the invention do not have a graduated distribution (where there is a gradual transition from one fiber type to a second fiber type within a single, unitary matrix or web of fibers). Instead, embodiments of the invention provide a non-woven product with a laminate structure and more distinct layers of different types of fibers.

Other aspects and embodiments of the invention will become apparent by consideration of the detailed description and accompanying drawings.

### BRIEF DESCRIPTION OF THE DRAWINGS

FIG. 1 is a schematic illustration of a five-stream manufacturing line and process of making a non-woven, multiple layer sheet of material in accordance with one embodiment of the invention.

FIGS. 2A and 2B illustrate processes of creating a non-woven sheet.

FIG. 3 is a schematic illustration of a manufacturing line having a forming station, a hydroentangling station, and a winder.

FIG. 4 is a schematic illustration of a manufacturing line having a forming station, a bi-component bonding oven, a cooling station, and a winder.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

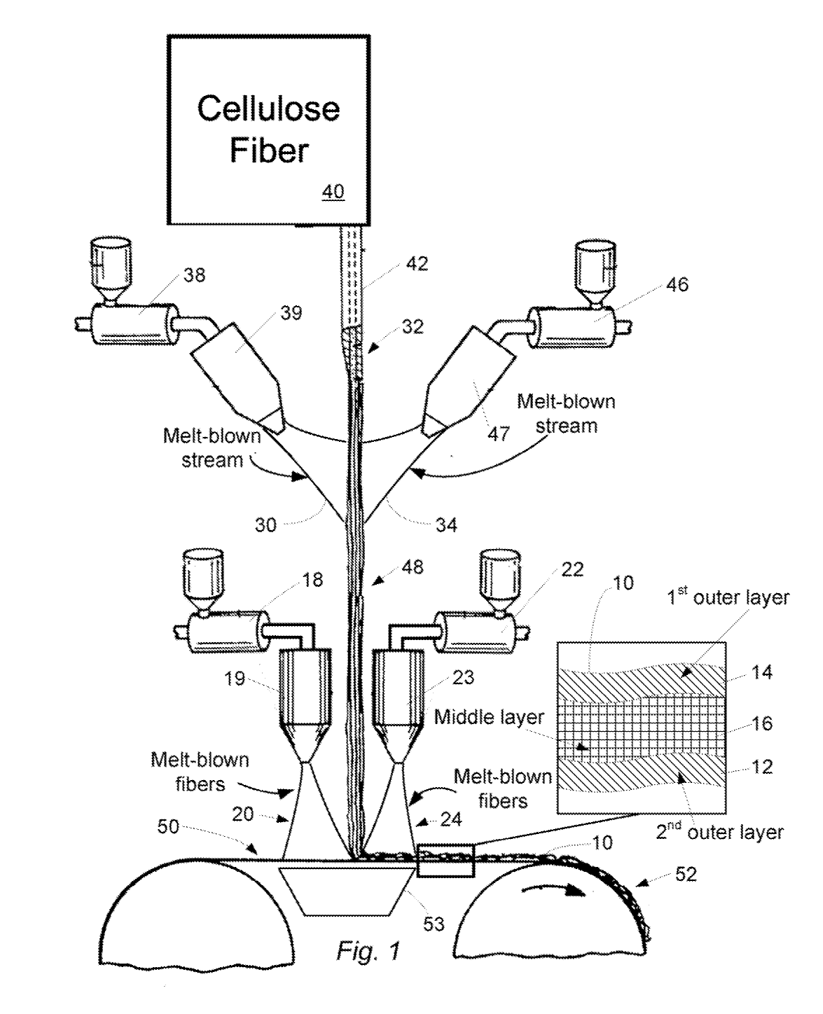

FIG. 1 is a schematic illustration of a manufacturing line configured to produce a non-woven, laminate sheet 10. The sheet 10 can (after appropriate converting (slitting, cutting, etc.)) be used as a dry wipe or a wet-wipe (after being impregnated or wetted with a liquid such as a cleansing solution, a medicinal solution, or the like). The sheet 10 includes a first, outer (or exterior) layer 12, a second, outer (or exterior) layer 14, and a third, middle layer 16. In one embodiment the first and second outer layers 12 and 14 are substantially the same thickness and both of them are thinner than the middle layer 16. The first and second layers are made from thermo-plastic melt-blown fibers. In one embodiment, the concentration of melt-blown fibers in the first and second layer 12 and 14 is 100%. In one embodiment, the melt-blown fibers in the first and second outer layers are high-strength fibers. In a particular embodiment, the high-strength fibers exhibit a strength or fiber tenacity (measured in grams per denier (“gpd”)) of at least about 5.0. Such fibers can be produced in a process in which a flow of quench air is directed at molten fibers exiting the nozzles or die bodies of an extruder parallel to the direction in which the fibers exit the die bodies. Processes and equipment for making such high-strength fibers are disclosed in U.S. Pat. No. 6,013,223, which is incorporated by reference herein.

As is discussed in greater detail, the third, middle layer 16 is made from cellulose, a mixture of cellulose and synthetic fibers (such as melt-blown fibers), or other fibers whether alone or in a mixture. By reducing the thickness of the layers 12 and 14 and keeping the use of petroleum-based, synthetic fibers in the middle layer 16 relatively low, cost sensitivity due to changes in the price of oil is reduced.

A first extruder 18 having a die body 19 produces a stream 20 of melt-blown fibers that form the first layer 12. The die body 19 (like other die bodies discussed) may include a plurality of rows of holes from which the melt-blown fibers are extruded. A die body suitable for use in at least some embodiments is a Biax type die body available from Biax-Fiberfilm Corporation. A second extruder 22 having a die body 23 produces a stream 24 of melt-blown fibers that form the second layer 14. In one embodiment, the middle layer 16 is made from a single type of fiber such as cellulose fibers. FIG. 1 one illustrates an optional embodiment where the middle layer 16 is a matrix of melt-blown fibers and a second type of fibers such as cellulose fibers. In the illustrated embodiment, the middle layer 16 is formed from three streams 30, 32, and 34 of fibers. If a single type of fiber is used, only one stream, the stream 32, is used. Stream 30 consists of melt-blown fibers formed by a third extruder 38 having a die body 39. Stream 32 consists of a second type of fibers. In the embodiment shown, a source 40 of cellulose feeds cellulose fibers to a nozzle or cellulose delivery system 42 which forms the stream 32. Stream 34 consists of melt-blown fibers from a fourth extruder 46 having a die body 47. The die bodies 39 and 47 and cellulose delivery system 42 are oriented so that the streams 30, 32, and 34 mix with one another to form a homogenized stream 48 of melt-blown and cellulose fibers. The middle layer 16 may be formed in accordance with the teachings of U.S. Pat. No. 4,100,234 (the “'234 patent”), which is incorporated by reference herein. The '234 patent describes a method of creating a homogenization of melt-blown and other types of fibers.

If melt-blown fibers are used in the third, middle layer, they can be low-strength fibers (e.g., fibers having a fiber tenacity of about 4 gpd or less) or high-strength fibers (e.g., fibers having a fiber tenacity of about 5 gpd or more). Other combinations or substitutions of fibers are also possible. For example, the third, middle layer can be made exclusively of cotton fibers, cellulose and cotton fibers, or a combination of cellulose, cotton fibers, and melt-blown fibers. As noted, lower strength meltbown fibers tend to be of high denier (i.e. thicker). When combined with the cellulose fibers, these thicker denier fibers produce a bulky middle layer that is also more absorbent.

Fibers in the first, second, and third layers may also be mixed with bicomponent fibers (e.g., fibers with a co-axial or side-by-side arrangement of synthetic fibers with different melting points, where a higher-melting point fiber is surrounded by or adjacent to a lower-melting point fiber).

In the embodiment shown, the first and second outer layers 12 and 14 are substantially identical and are made from melt-blown fibers having a relatively low denier. Using a low-denier or fine fiber produces a smooth surface. Removing cellulose from the first and second outer layers reduces linting (because cellulose fibers tend to lint). As noted above, the sheet 10 can be produced using five fiber streams. Three center streams 30, 32, and 34 are used to make the middle layer 16. Each stream 30 and 34 is generated by an extruder having a die or nozzle sized to produce fibers with a higher denier than the melt-blown fibers produced by the extruders 18 and 22 (which are used in the first and second outer layers 12 and 14). Using higher denier or coarser fibers in the middle layer 16 helps to provide bulk to the sheet 10.

In alternative embodiments, the composition of the middle layer 16 is varied. In one example, the stream 32 consists of cotton or other natural fibers instead of cellulose. In another example, the stream 32 is a mixture of cellulose and cotton fibers. In another embodiment, bicomponent staple fiber (i.e., a fiber cut to length) is added to the middle layer 16 instead of or in combination with the melt-blown fibers from streams 30 and 34.

The streams 20 and 24 are directed onto a continuous belt 50 of a forming table 52. The forming table includes a vacuum box or plenum 53. The vacuum plenum 53 is connected to a vacuum source which pulls or vacuums the fibers onto the continuous web 50 to form a non-woven web of material. The die bodies 19 and 23 are oriented so that the streams 20 and 24 do not mix with the stream 36. As a consequence, the sheet 10 has three, distinct layers: two outer layers that are composed of melt-blown fibers and a middle-layer that is a mixture of fibers formed by the streams 30, 32, and 34.

In an alternative embodiment of the invention, the melt-blown fibers are bicomponent fibers (e.g., fibers with a co-axial or side-by-side arrangement of synthetic fibers with different melting points, where a higher-melting point fiber is surrounded by or adjacent to a lower-melting point fiber). Melt-blown bicomponent fibers are continuous fibers. After the product 10 is formed using bicomponent fibers, it is heated in an oven (or similar device) such that the lower-melting point layer of the bicomponent fibers melts or becomes tacky. Fibers in the product (both melt-blown, cellulose, and other fibers) adhere to the molten layer of the bicomponent fibers. When the product 10 cools, thermal bonds are created between the fibers. Bonding or fusing through the use of bicomponent fibers aids in the adhesion of all of the fibers (which increases the overall strength of the product 10) and also increases the strength and decreases the linting of the shorter fibers in the product 10.

In a second alternative embodiment, once the multiple-layer or laminate sheet is formed the three layers (the first and second outer layers and the third, middle layer) are bonded or more securely attached to one another through hydroentangling the fibers in the layers. Hyrdoentangling the layers 12, 14, and 16 helps bond the layers together and prevents the layers from separating from one another. Hyrdoentangling may be use as a substitute to using bicomponent fibers or in combination with the use of bicomponent and thermal bonding.

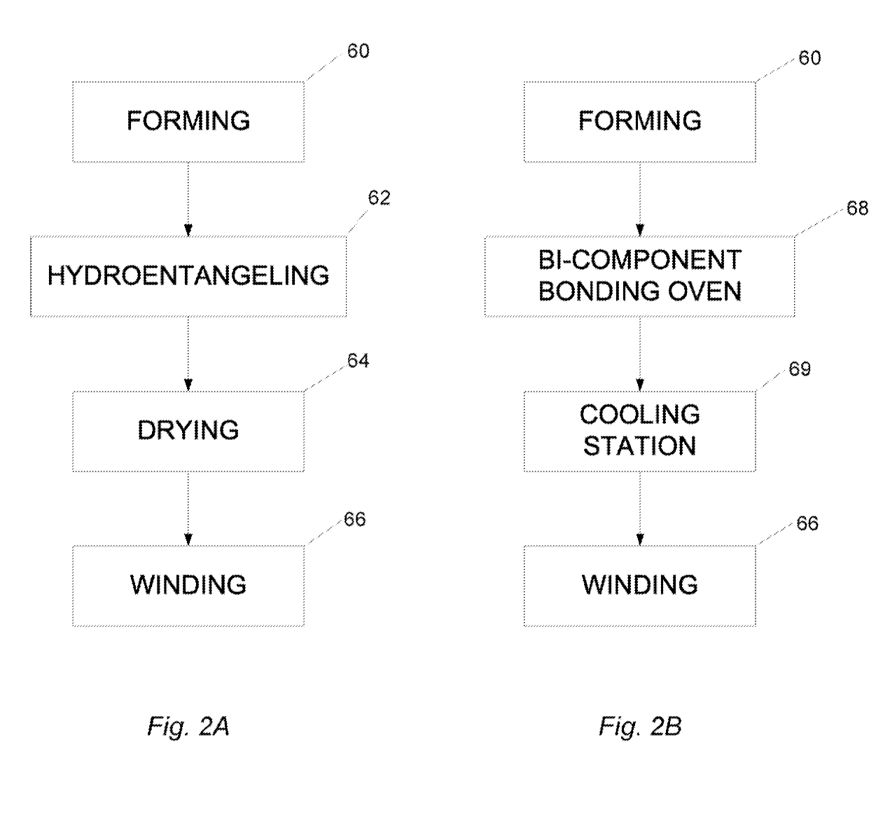

FIG. 2A illustrates processes of forming a non-woven product using the sheet 10. At step 60 the non-woven sheet 10 is formed (in accordance with the description above). The sheet is then hydroentangled (step 62). After the sheet or, more particularly, the layers 12, 14, and 16 of the sheet are hydroentangled, the sheet is dried (step 64). The dried sheet is then wound into a roll (step 66). In alternative embodiments where bicomponent fiber is used (FIG. 2B), steps 62 and 64 are omitted and the sheet 10 is heated (for example, in an oven) (step 68) to cause the low-temperature portion of the bicomponent fibers to melt and subsequently cooled (step 69) (to create bonds), before being wound into a roll.

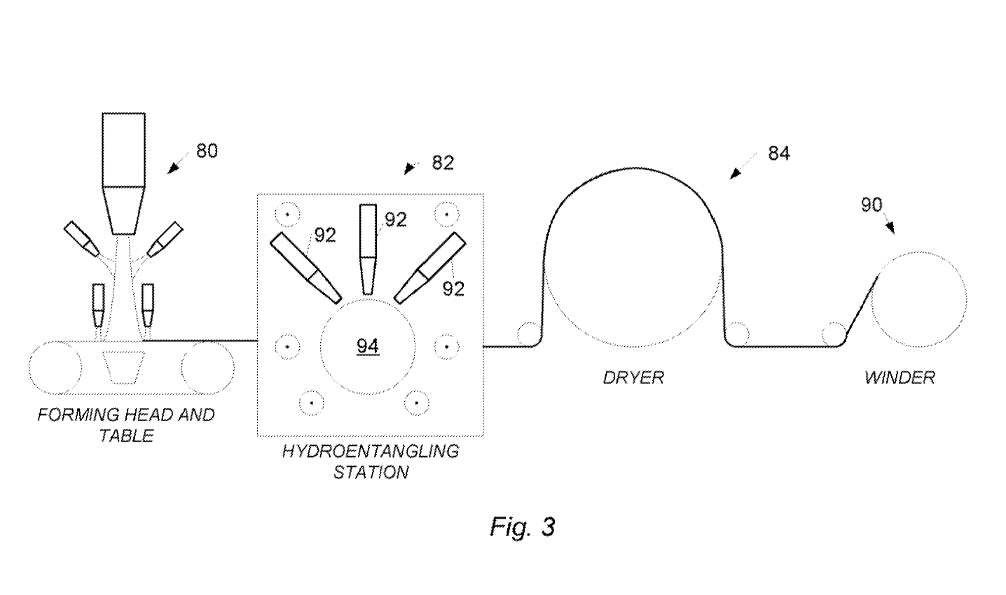

FIG. 3 is a schematic illustration of a manufacturing line having a forming station 80 (such as the forming station shown in FIG. 1), a hydroentangling station or section 82, and a winder 90. The sheet 10 is sent from the forming station 80 to the hydroentangling section 82. The hydroentangling station 82 includes multiple water nozzles 92 which are designed to produce jets of water. The hydroentangler also has a cylindrical drum 94. The circumferential surface of the drum has numerous openings. The sheet 10 is directed over the drum 94 and the jets of water produced by the nozzles 92 strike the surface of the sheet. The impact of the water (including richochets off of the drum) causes the fibers in the layers of the sheet to move and be entangled with one another, thereby increasing the strength of the web. After it is hydroentangled, the sheet 10 is sent to the dryer 84. After being dried, the sheet 10 is sent to the winder 90, where it is wound to create a master or parent roll.

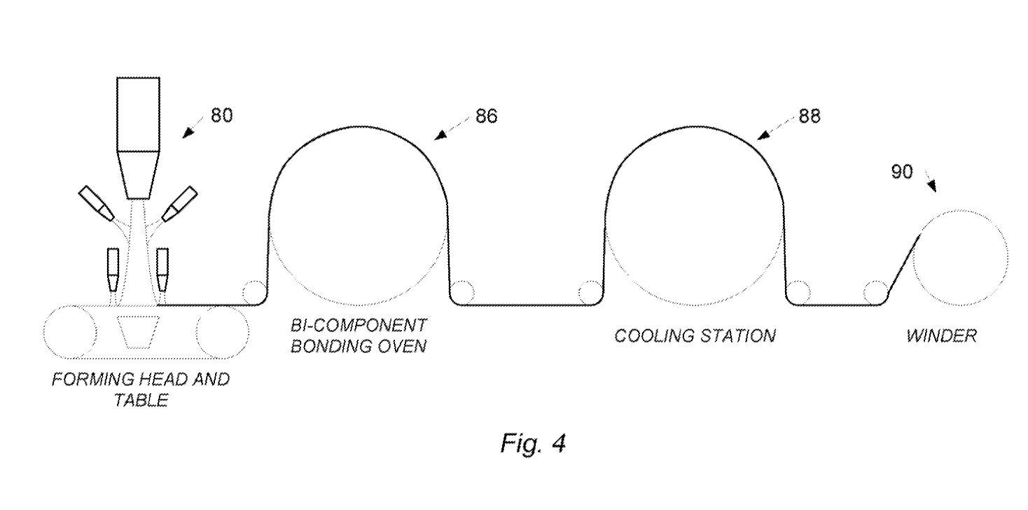

In embodiments that use bicomponent fiber (instead of hydroentangling), the sheet is passed through an oven 86 and cooling station 88 before being sent to the winder 90. FIG. 4 is a schematic illustration of such an embodiment. In the embodiment shown in FIG. 4, the sheet 10 is held together with bonds created by bicomponent fiber. The manufacturing line in FIG. 4 includes the forming station 80 (such as the forming station shown in FIG. 1), the bonding oven 86, the cooling station or section 88, and the winder 90.

Thus, embodiments of the invention provide, among other things, laminate non-woven wipes in which the amount of melt-blown material may be controlled. Various features and advantages of the invention are set forth in the following claims.

1. A laminate non-woven sheet comprising:
a first layer consisting of 100% melt-blown fibers, the first layer having a thickness and the melt-blown fibers having a denier;
a second layer consisting of 100% melt-blown fibers, the second layer having a thickness, and the melt-blown fibers having a denier; and
a middle layer positioned between the first and second layers, the middle layer including a dry-laid web of cellulose fibers and at least one selected from the group of melt-blown fibers and bicomponent fibers, the cellulose fibers having a denier,
wherein the fibers within the middle, first, and second layers and the middle layer, the first layer, and the second layer are secured to each other by at least one of a group of bonds created
by fusing melt-blown fibers in the first and second layers with each other and with fibers in the middle layer,
by fusing bicomponent melt-blown fibers in the first and second layers with each other and fibers in the middle layer,
by fusing bicomponent staple fibers in the middle layer with fibers in the first and second layers, and
hydroentangling the first, second, and middle layers.

2. A laminate as claimed in claim 1, wherein the melt-blown fibers in the first and second layers consist of melt-blown fibers extruded through a die-body having a plurality of rows of holes.

3. A laminate as claimed in claim 2, wherein the melt-blown fibers are quenched by air as they exit the die body.

4. A laminate as claimed in claim 1, wherein the denier of the fibers in the middle layer is greater than the denier of the melt-blown fibers in the first and second layers.

5. A laminate as claimed in claim 1, wherein the melt-blown fibers in the first layer have a strength of at least about 5 gpd.

6. A laminate as claimed in claim 1, wherein the melt-blown fibers in the second layer have a strength of at least about 5 gpd.

7. A laminate as claimed in claim 1, wherein the thickness of the first layer is the same as the thickness of the second layer.

8. A laminate as claimed in claim 1, wherein the middle layer is a homogenization of melt-blown fibers and other fibers.

9. A laminate as claimed in claim 1, wherein the middle layer includes bicomponent fiber.

10. A method of manufacturing a laminate, the method comprising:
extruding melt-blown fibers to form a first layer consisting of melt-blown fibers, the melt-blown fibers having a strength of at about 5 gpd or more and the first layer having a thickness;
depositing at least one of cellulose and a mixture of cellulose and another type of fiber on top of the first layer to form a dry-laid web of fibers;
extruding melt-blown fibers to form a second layer consisting of melt-blown fibers, the melt-blown fibers having a strength of about 5 gpd or more and the second layer having a thickness that is substantially the same as the thickness of the first layer;
depositing the second layer on top of the dry-laid web of fibers so that the dry-laid web of fibers is positioned between the first and second layers to form a middle layer; and
securing the middle layer to the first and second layers by at least one of a group of bonds created by fusing bicomponent fiber or hydroentangling of the first, second, and middle layers.

11. A method as claimed in claim 10, wherein extruding melt-blown fibers to form a first layer consisting of melt-blown fibers includes extruding the melt-blown fibers through a die-body having a plurality of rows of holes.

12. A method as claimed in claim 11, further comprising directing quench air at the melt-blown fibers as they exit the die body.

13. A method as claimed in claim 11, furthering comprising extruding melt-blown fibers so that they have a denier that is less than the denier of the fibers in web of cellulose fibers.

14. A system for manufacturing a laminate non-woven sheet, the system comprising:
a forming table;
a source of cellulose fibers positioned above the forming table and configured to generate a stream of cellulose fibers;
a first extruder positioned above the forming table and having a die body configured to generate a first stream of melt-blown fibers, the first die-body oriented to direct the first stream of melt-blown fibers into the stream of cellulose fibers;
a second extruder positioned above the forming table and having a second die body configured to generate a second stream of melt-blown fibers, the second die-body oriented to direct the second stream of melt-blown fibers into the stream of cellulose fibers;
a third extruder positioned above the forming table and having a third die body configured to generate a third stream of melt-blown fibers, the third die-body oriented to direct the third stream of melt-blown fibers on to the forming table without interacting with the stream of cellulose fibers before the third stream of melt-blown fibers contacts the forming table,
wherein the source of cellulose is configured to direct the stream of cellulose so that it is deposited on top of the third stream of melt-blown fibers after the third stream of melt-blown fibers contacts the forming table; and
a fourth extruder having a fourth die body configured to generate a fourth stream of melt-blown fibers; the fourth die-body of the fourth extruder oriented to direct the fourth stream of melt-blown fibers toward the forming table without interacting with the stream of cellulose fibers before the fourth stream of melt-blown fibers reaches the forming table.

15. A system as claimed in claim 14, further comprising an oven located downstream from the forming head.

16. A system as claimed in claim 14, further comprising a hydroentangler located downstream from the forming head.
